(19) United States
(12) Patent Application Publication
(10) Pub. No.: US 2022/0369651 A1
(43) Pub. Date: Nov. 24, 2022

(54) NATURAL PEST REPELLANT FORMULATIONS AND METHODS OF USE

(71) Applicant: Bug Bite Barrier, LLC, Colorado Springs, CO (US)

(72) Inventor: Susan M. Luck, Colorado Springs, CO (US)

(73) Assignee: Bug Bite Barrier, LLC, Colorado Springs, CO (US)

(21) Appl. No.: 17/663,932

(22) Filed: May 18, 2022

Related U.S. Application Data
(60) Provisional application No. 63/189,773, filed on May 18, 2021.

(51) Int. Cl. A01N 65/22; A01N 65/44

(52) U.S. Cl. CPC A01N 65/22; A01N 65/44

(57) ABSTRACT

The disclosed pest repellants are comprised of dried rosemary leaves and dried lavender buds that are infused into a volume of water. Some embodiments include one or more of the following: basil leaves, lemon grass, thyme leaves, and/or oregano leaves. Other embodiments of the disclosed invention include methods for preparing the pest repellent comprising rosemary leaves, lavender buds, and in some embodiments basil leaves, lemon grass, thyme leaves and/or oregano leaves. The disclosed methods comprising heating water to boiling or near boiling, steeping a package of herbal mix in the water for a period of time, removing the package from the infusion, diluting the infusion to the desired strength, and placing the repellant into a sprayer.

### CROSS-REFERENCE TO RELATED APPLICATIONS

This application claims priority to U.S. Provisional Application No. 63/189,773, filed May 18, 2021, the disclosure of which is hereby incorporated herein by reference in its entirety.

### BACKGROUND

### Field of the Invention

The present invention relates to natural, biodegradable, and hypoallergenic formulations of pest repellents, as well as methods for preparation and use of repellents.

### Relevant Background

Certain pests can be annoying or dangerous for humans, pets, and livestock. Insects and rodents can transmit parasites and infections, many insects cause painful or itchy bites, and degrade the enjoyment of being outdoors. Pest repellents currently on the market often rely on pesticides and other dangerous chemicals that may harm the user, or pass into and linger in the environment. For those that are allergic or sensitive to such chemicals, there is often no alternative except to endure insect bites, to cover up the body completely, or to remain indoors. Existing pest repellents are either not made from natural ingredients that are biodegradable and hypoallergenic, or are incapable of effectively mitigating the danger and nuisance of pest infestations on humans and other animals. Further, chemical pest repellents are expensive, and therefore of limited use for larger scale uses such as on farms, zoos, or other commercial areas. In addition to potentially harming humans and other animals exposed to then, existing chemical repellants also may harm the pests that are to be driven away.

As is apparent from the above discussion, current pest repellants have a number of shortcomings that expose users to serious risk of injury, discomfort, or inconvenience. Therefore, it is apparent that a need exists for effective repellant formulations that are safe for use on adult and juvenile humans, pets, livestock, (and pests as well), that do not persist in the environment, and that do not cause allergic reactions in users. The disclosed invention addresses the stated needs, in part, through ingredients that are safe, natural, and hypoallergenic.

Pest repellants with the disclosed features will greatly reduce the stated and obvious risks of using other existing repellants on humans, pets, and livestock. These and other deficiencies of the prior art are addressed by one or more embodiments of the disclosed invention. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out hereafter.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings and figures imbedded in the text below and attached following this description.

FIG. 1 is a flow chart depicting a stage of preparation of disclosed pest repellant.

FIG. 2 is a flow chart depicting a stage of preparation of disclosed pest repellant.

FIG. 3 is a depiction of different strengths of the disclosed pest repellant.

The Figures depict embodiments of the present invention for purposes of illustration only. One skilled in the art will readily recognize from the following discussion that alternative embodiments of the structures and methods illustrated herein may be employed without departing from the principles of the invention described herein.

### Definitions

“Infusion” means a liquid resulting from a process of extracting chemical compounds from plant material by steeping it in boiling or nearly boiling water. As used herein, an infusion may also be made by decoction or boiling the plant material in water.

“Herb,” or “herbal” means plants with savory or aromatic properties generally used for culinary or medicinal purposes. As used herein, herbs may include the leaves and flower portions of plants, but also includes other parts of plants, such as seeds, bark, roots and fruits, that are typically known as “spices.”

“Hypo-allergenic” means causing fewer or less severe allergic reactions in humans exposed to ingredients of the disclosed herbal mixtures. Such a description does not require official certifications, nor does it preclude some individuals from having allergic reactions to certain included ingredients.

### DETAILED DESCRIPTION OF THE INVENTION

The disclosed invention will be primarily, but not entirely, limited to all natural pest repellant compositions, methods of manufacture, and methods of use.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the disclosed invention are provided for illustration purpose only and not for the purpose of limiting the invention as defined by the appended claims and their equivalents.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a nonexclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

### Natural Pest Repellent

The disclosed pest repellant is made from natural, food-grade ingredients, is hypo-allergenic and biodegradable. Pest repellants described herein are comprised of rosemary leaves (Salvia romarinas) and lavender buds (Lavandula angusifolia), and some embodiments include one or more of the following: basil leaves (Ocimum basilicum), lemon grass (Cymbopogon citratus), thyme leaves (Thymus vulgaris), and/or oregano leaves (Origanum vulgare).

The disclosed invention also provides a method for preparing a pest repellant composition comprising rosemary leaves, lavender buds, and in some embodiments basil leaves, lemongrass, thyme leaves and/or oregano leaves, wherein the method comprises washing the herbs, drying the washed herbs, e.g., at about 175 to 212 degrees Fahrenheit (° F.) to less than 10% water content, sieving the herbs to remove fine particles, mixing a portion of the herbs together until a uniform mixture is achieved, dividing the mixture into equal portions, e.g., about 1 to 3 teaspoons, and packaging each portion of the herbal mix into a package, e.g., an infusion bag.

The disclosed invention also provides a method for preparing the pest repellent comprising rosemary leaves, lavender buds, and in some embodiments basil leaves, lemon grass, thyme leaves and/or oregano leaves, wherein the method comprises heating water to boiling or near boiling, e.g., 200 to 212° F., steeping a package of herbal mix in the water for 4 to 5 minutes, removing the package from the infusion, diluting the infusion to the desired strength, and placing the repellant into a sprayer.

The disclosed invention will now be described in detail with reference to several embodiments thereof as illustrated in the accompanying Figures. In the following description, numerous specific details are set forth in order to provide a thorough understanding of embodiments of the invention. It will be apparent, however, to one skilled in the art that embodiments may be practiced without some or all of these specific details. In other instances, well known process steps and/or structures have not been described in detail in order to not unnecessarily obscure the disclosed invention. The features and advantages of embodiments may be better understood with reference to the drawings and discussions that follow.

The disclosed pest repellant is designed for safe use on adults, children, pets, and livestock. The repellant is a tea-like brew or herbal infusion of natural, organic, and hypo-allergenic herbs and spices. The infusion is made from food-grade materials, allowing it could be consumed without harm. The infusion has a scent that is unpleasant to insects and most rodents, causing them to leave sprayed areas and to reduce biting behaviors. When applied to skin, hair, or fur the infusion creates a natural protective barrier between the animal and biting insects. It can be applied indoors or outdoors, and can be sprayed in open areas, or on surfaces, such as grass, ceilings, and exterior or interior building walls.

The disclosed pest repellant is made of dried herbs and spices, with some embodiments comprising a mix of rosemary leaves (Salvia rosmarinus) and lavender buds (Lavandula angustifolia). Other embodiments of the disclosed pest repellant also include one or more of the following: basil leaves (Ocimum basilicum), lemon grass (Cymbopogon citratus), thyme leaves (Thymus vulgaris) and oregano leaves (Origanum vulgare). Specifically, some embodiments of the herbal mix include 1 to 99% by weight (w) rosemary leaves, and 1 to 99% (w) lavender buds. Some embodiments of the herbal mix include 10 to 80% (w) rosemary leaves, and 10 to 80% (w) lavender buds. Some embodiments of the herbal mix include 20 to 60% (w) rosemary leaves, and 20 to 60% (w) lavender buds. Some embodiments of the herbal mix include 30 to 50% (w) rosemary leaves, and 30 to 50% (w) lavender buds. Other embodiments of the herbal mix include 1 to 99% (w) rosemary leaves, 1 to 99% (w) lavender buds, 0 to 99% (w) basil leaves, 0 to 99% (w) lemon grass. 0 to 99% (w) thyme leaves, and 0 to 99% (w) oregano leaves. Some embodiments of the herbal mix include 10 to 80% (w) rosemary leaves, 10 to 80% (w) lavender buds, and 10 to 80% (w) of one or more of: basil leaves, lemon grass, thyme leaves, and oregano leaves. Some embodiments of the herbal mix include 20 to 60% (w) rosemary leaves, 20 to 60% (w) lavender buds, and 20 to 60% (w) of one or more of: basil leaves, lemon grass, thyme leaves, and oregano leaves. Some embodiments of the herbal mix include 30 to 50% (w) rosemary leaves, 30 to 50% (w) lavender buds, and 30 to 50% (w) of one or more of: basil leaves, lemon grass, thyme leaves, and oregano leaves.

The herbal mix used can vary according to specific application needs. Rosemary leaves and branches have been used for thousands of years to repel pests. Typically, rosemary would be burned and the plant oils would enter the air in the vicinity of the fire to repel flying insects. Because of its usefulness as a pest repellant and historically cheaper cost than other potential ingredients having bug repellant properties, rosemary forms the basis of most embodiments of the disclosed pest repellant composition. Oils extracted from lavender buds are similarly effective at repelling pests, and as a result, most embodiments will include 10% (w) or more lavender buds. The remaining listed herbs are more or less equivalently effective as pest repellants, however, they are typically more expensive than rosemary or lavender, and therefore may be featured in lower percentages than rosemary or lavender. Certain applications may benefit from alternate aromatic profiles that result from use of the other herbs. For example, users of the disclosed pest repellants may prefer a dominant basil scent rather than a dominant rosemary scent. Herbal mixes with different scent profiles may be required, if, for example, pests in an area become accustomed to a dominantly rosemary scent, and are no longer repelled from an area. Many combinations of herbs are possible and contemplated. The herbs referenced herein may be included in the herbal mix as specifically referenced parts of the plant, e.g., leaves, buds, etc., but in some embodiments may include any part of the plant, including its leaves, bark, stem, root, buds, and/or flowers. Additionally, component plant parts can be young, old, fresh, dried, raw, or processed.

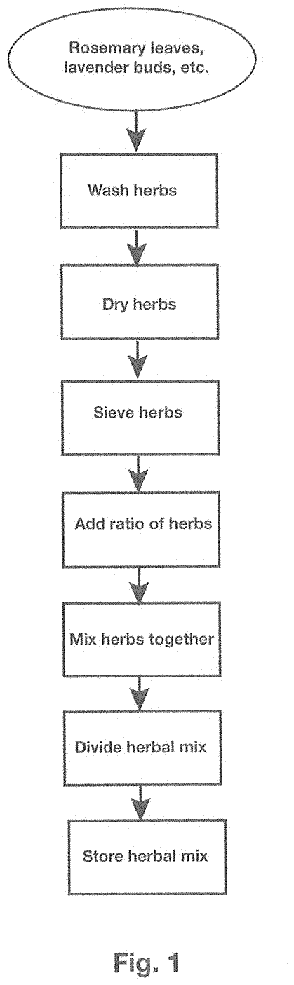

With reference to FIG. 1, the herbs are prepared for use in the disclosed pest repellant by means of a method of manufacture. The disclosed method includes washing the herbs to remove debris, insect parts, dirt, pesticides, and any other contaminants. Once the herbs are washed, they are dried by the application of heat in a low humidity environment. For example, the herbs may be heated at temperatures ranging from 175 to 212° F. until they are dried to less than 10% (w) of water content. The dried herbs are then run through a sieve to remove fine particles, such as overly crushed leaves, or remaining dirt. The sieved herbs are then added together according to the formula used for the particular repellant application. For example, the herbal mix may include 90% rosemary leaves and 10% lavender buds. Other embodiments may include, e.g., 80% rosemary, 10% lavender buds, and 10% oregano leaves. Once the proper proportion of herbs is achieved, the herbs are mixed together to form a uniform mixture. The herbal mix is then divided into equal portions, e.g., 1 to 3 teaspoons, each of which is packaged in an infusion bag. Infusion bags may be made from, e.g., filter paper, cellulose, cotton, silk, plastic, polylactide, corn starch, or nylon. However, biodegradable and natural materials are preferred. The infusion bags are sealed to retain the herb mix, and further may include an attached string to aid in removal of the bag from hot water. In some embodiments, the individual infusion bags are packaged together in a secondary package. In some embodiments, rather than packaging the herbal mix in individual infusion bags, the mix is contained in a resealable airtight container holding several uses, e.g., 1 cup, of loose herbal mix. For such embodiments, a portion of loose herbal mix may be measured out and placed in a metal strainer, such as are used for brewing teas. The compact and portable nature of the herb mix promotes convenience of use, inexpensive transport, and reduced storage requirements.

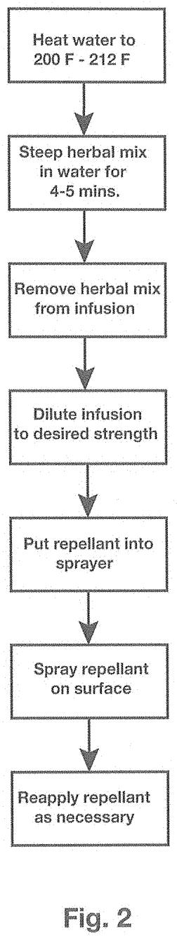

With reference to FIG. 2, the disclosed invention also involves a method for preparing the pest repellent for use. The herbal mix ingredients, i.e., rosemary leaves and lavender buds, and in some embodiments, basil leaves, lemon grass, thyme leaves and/or oregano leaves, are contained in an infusion bag containing, e.g., 1 to 3 tsp. of herbal mix. For loose leaf embodiments, a similar amount of loose leaf herbal mix is taken from the resealable container, and placed in a mesh strainer. Then approximately 1 gallon of water is heated to between 200 and 212 degrees Fahrenheit (° F.), and an infusion bag or mesh strainer containing the herbal mix is steeped in the hot water for approximately four to five minutes. Larger infusion bags, for example holding 7 tablespoons (Tbsp.), or about ½ cup, of herbal mix can be steeped in up to 20 gallons of water. Quantities of herbal mix, and hence the amount of repellant produced, may vary widely, from ¼ tsp. infused into about 2 cups of water, to 21 cups of herbal mix infused into about 1,000 gallons of water. The amount of water and the duration of steeping time can be varied to produce a stronger or weaker infusion, where shorter steeping times and larger volumes of water tend to weaken the infusion. Water for the infusion may be heated as suitable for the application, e.g., on a kitchen stove top, a campfire, an outdoor propane cooker, a solar heater, etc.

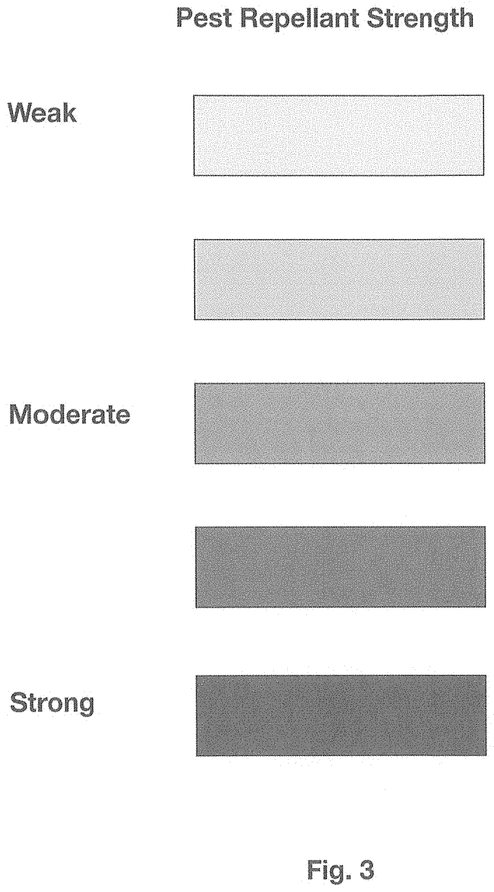

Once steeped, the infusion bag or mesh strainer are removed, and the repellant is allowed to cool. The repellant may also be diluted with additional cold water as needed before use. With reference to FIG. 3, some embodiments include the use of a color chart, wherein shades of the repellant are classified according to strength. The user may dilute the infusion until the color of the infusion matches the selected section of the color chart, and therefore achieves the selected strength of the repellant. Then the repellant is placed in a spray bottle for smaller applications, or a larger pump-type sprayer, or commercial-type towed sprayer for applications to larger areas. Alternate application methods include pouring or sprinkling the repellant directly onto areas to be treated. The repellant may be poured into fountains to produce a pest-repelling mist around the fountain. The repellant may also be poured into open water sources used for livestock, such as a water trough, so that the repellant can keep pests away.

The repellant is designed to be used wherever insects or rodents infest an area and cause a nuisance. Specifically, it may safely be applied directly to human skin, pets, and livestock. It is also suitable for application to various surfaces, including on, in, and/or around the following: barns, commercial areas, sports fields, pools, homes, patios, gardens, lawns, bushes, and other plants. Some surfaces that are prone to damage by water should be avoided, such as fine furniture or documents. The repellent does not harm the pests, rather it discourages them from lingering in the sprayed area or from lighting on sprayed surfaces. Because dangerous chemicals are not used, the disclosed repellant is better for the environment, and is better for any plants and animals exposed to the repellant, than is the case for traditional pest repellants.

Because the mixture is water soluble, it should be reapplied if the application surface is exposed to water (such as after swimming or excess sweating in the case of humans), or exposure to rain, or high humidity conditions. In dry conditions, the repellant persists on the sprayed area, and retains effectiveness for about a week before reapplication is required. Larger groups of livestock, such as cattle, chickens, or pigs, may require more frequent applications.

While this invention has been described in terms of several embodiments, there are alterations, modifications, permutations, and substitute equivalents, which fall within the scope of this invention. Although subsection titles have been provided to aid in the description of the invention, these titles are merely illustrative and are not intended to limit the scope of the present invention. In addition, where claim limitations have been identified, for example, by a numeral or letter, they are not intended to imply any specific sequence. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

As will be understood by those familiar with the art, the disclosed invention may be embodied in other specific forms without departing from the spirit or essential characteristics thereof. Likewise, the particular naming and division of the modules, managers, functions, systems, layers, features, attributes, methodologies, and other aspects are not mandatory or significant, and the mechanisms that implement the invention or its features may have different names, divisions, and/or formats. Accordingly, the disclosure of the present invention is intended to be illustrative, but not limiting, of the scope of the invention.

While this invention has been described in terms of several embodiments, there are alterations, modifications, permutations, and substitute equivalents, which fall within the scope of this invention. Although subsection titles have been provided to aid in the description of the invention, these titles are merely illustrative and are not intended to limit the scope of the present invention. In addition, where claim limitations have been identified, for example, by a numeral or letter, they are not intended to imply any specific sequence. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

This has been a description of the disclosed invention along with a preferred method of practicing the invention, however the invention should be defined by the appended claims.

What is claimed is:

1. A natural pest repellent, comprising:
a proportion of dried rosemary leaves;
a proportion of dried lavender buds; and
a volume of water.

2. The natural pest repellant of claim 1, further comprising:
a proportion of one or more of the following: dried basil leaves, dried lemon grass, dried thyme leaves, and dried oregano leaves.

3. The natural pest repellant of claim 1, wherein the proportion of dried rosemary is 90%, and the proportion of dried lavender buds is 10%.

4. The natural pest repellant of claim 1, wherein the proportion of dried rosemary is 80%, the proportion of dried lavender buds is 10%, and a proportion of dried oregano leaves is 10%.

5. The natural pest repellant of claim 1, wherein the volume of water is adjusted to control a strength of a repellant infusion.

6. A method for preparing a natural pest repellent, comprising:
drying rosemary leaves and lavender buds;
mixing together a proportion of dried rosemary leaves and a proportion of dried lavender buds to form an herbal mix;
placing the herbal mix into an infusion bag to form a repellant package;
heating a volume of water to a temperature at a boiling point of water or near the boiling point of water
steeping the repellant package in the volume of water for a time period to form a repellant infusion;
removing the repellant package from the repellant infusion;
diluting the repellant infusion to a desired strength;
cooling the repellant infusion; and
placing the repellant infusion into a sprayer.

7. The method for preparing a natural pest repellent of claim 6, further comprising:
drying one or more of the following: basil leaves, lemon grass, thyme leaves, and oregano leaves;
mixing together a proportion of dried rosemary leaves and a proportion of dried lavender buds, and a proportion of one or more of the following to form the herbal mix: dried basil leaves, dried lemon grass, dried thyme leaves, and dried oregano leaves.

8. The method for preparing a natural pest repellent of claim 6, further comprising: heating the volume of water to a temperature between 200 and 212 degrees Fahrenheit.

9. The method for preparing a natural pest repellent of claim 6, wherein the time period is 4 to 5 minutes.

10. The method for preparing a natural pest repellent of claim 6, wherein ¼ teaspoon of herbal mix is infused into 2 cups of water.

11. The method for preparing a natural pest repellent of claim 6, wherein 21 cups of herbal mix is infused into 1,000 gallons of water.
